(19) United States
(12) Patent Application Publication
(10) Pub. No.: US 2014/0063664 A1
(43) Pub. Date: Mar. 6, 2014

(54) Ground Controlled Outlet

(71) Applicants: Richard A. Doggett, Tucson, AZ (US); Nathan L. Douglas, Tucson, AZ (US); Leslie Bush, Tucson, AZ (US)

(72) Inventors: Richard A. Doggett, Tucson, AZ (US); Nathan L. Douglas, Tucson, AZ (US); Leslie Bush, Tucson, AZ (US)

(73) Assignee: RAYTHEON COMPANY, Waltham, MA (US)

(21) Appl. No.: 13/600,703

(22) Filed: Aug. 31, 2012

(51) Int. Cl. H02H 9/04

(52) U.S. Cl. 361/56

(57) ABSTRACT

An electrostatic discharge (ESD) monitoring system includes a first switch device, a first outlet communicatively connected to the first switch device, and a logic portion communicatively connected to the first switch device, the logic portion operative to receive a signal from a ground strap monitor portion indicative of a status of the ESD monitoring system and change a state of the first switch device responsive to receiving the signal.

### BACKGROUND

The present disclosure relates to electrostatic discharge monitoring systems.

Electrostatic discharge (ESD) monitoring systems often include a ground strap such as, for example a wristband that may be connected to a the body of a technician to ground the technician and prevent undesired ESD, which may damage electronic equipment.

If the ground strap becomes unconnected from the technician, or if the system senses a loss of ground, a visual or audible indication may be output or exhibited.

### SUMMARY

According to one embodiment, an electrostatic discharge (ESD) monitoring system includes a first switch device, a first outlet communicatively connected to the first switch device, and a logic portion communicatively connected to the first switch device, the logic portion operative to receive a signal from a ground strap monitor portion indicative of a status of the ESD monitoring system and change a state of the first switch device responsive to receiving the signal.

According to another embodiment, a method of operating an electrostatic discharge (ESD) monitoring system includes determining whether a signal from a ground strap monitor portion indicative of an ungrounded status of the ESD monitoring system is receive, and affecting a connection between an alternating current (AC) voltage source and an outlet responsive to receiving the signal.

According to yet another embodiment, a method of operating an electrostatic discharge (ESD) monitoring system includes determining whether a signal from a ground strap monitor portion indicative of an ungrounded status of the ESD monitoring system is received, affecting a connection between an alternating current (AC) voltage source and a first outlet responsive to receiving the signal, and affecting a connection between the AC voltage source and a second outlet responsive to receiving the signal.

Additional features and advantages are realized through the techniques of the present disclosure. Other embodiments and aspects of the disclosure are described in detail herein and are considered a part of the claimed disclosure. For a better understanding of the disclosure with the advantages and the features, refer to the description and to the drawings.

### BRIEF DESCRIPTION OF THE SEVERAL VIEWS OF THE DRAWINGS

The subject matter which is regarded as the disclosure is particularly pointed out and distinctly claimed in the claims at the conclusion of the specification. The forgoing and other features, and advantages of the disclosure are apparent from the following detailed description taken in conjunction with the accompanying drawings in which:

FIG. 1 illustrates a block diagram of an exemplary embodiment of an ESD monitoring system.

FIG. 2 illustrates a block diagram of another exemplary embodiment of an ESD monitoring system.

FIG. 3 illustrates a block diagram of an exemplary method of operation of an ESD monitoring system.

FIG. 4 illustrates a block diagram of another exemplary method of operation of an ESD monitoring system.

FIG. 5 illustrates a block diagram of another exemplary method of operation of an ESD monitoring system.

FIG. 6 illustrates a block diagram of another exemplary embodiment of an ESD monitoring system.

FIG. 7 illustrates a block diagram of another exemplary embodiment of an ESD monitoring system.

### DETAILED DESCRIPTION

Previous electrostatic discharge (ESD) monitoring systems included a visual indicator such as an arrangement of lights that indicated whether a technician was properly grounded by a grounding strap. If, however, the technician does not realize that the light indication has changed as a result of the technician becoming ungrounded, an undesirable ESD may occur, which may damage electronic equipment. Some previous ESD monitoring systems included an audible alarm as well as a visual indicator. However, in some work environments, an audible alarm may become disruptive and undesirable.

The exemplary embodiments described herein provide for an ESD monitoring system that may be connected to an alternating current (AC) outlet that may be selectively controlled by the ESD monitoring system. In such embodiments, a technician may connect a variety of AC powered devices such as, for example, lights, fans, audio systems, or computer displays that may be switched off (or on) to indicate the status of the ESD monitoring system. For example, if a technician becomes ungrounded, the ESD monitoring system may turn off the AC outlet providing power to a work light. Thus, the technician may be made immediately aware of a loss of ground without disturbing other technicians in the work environment.

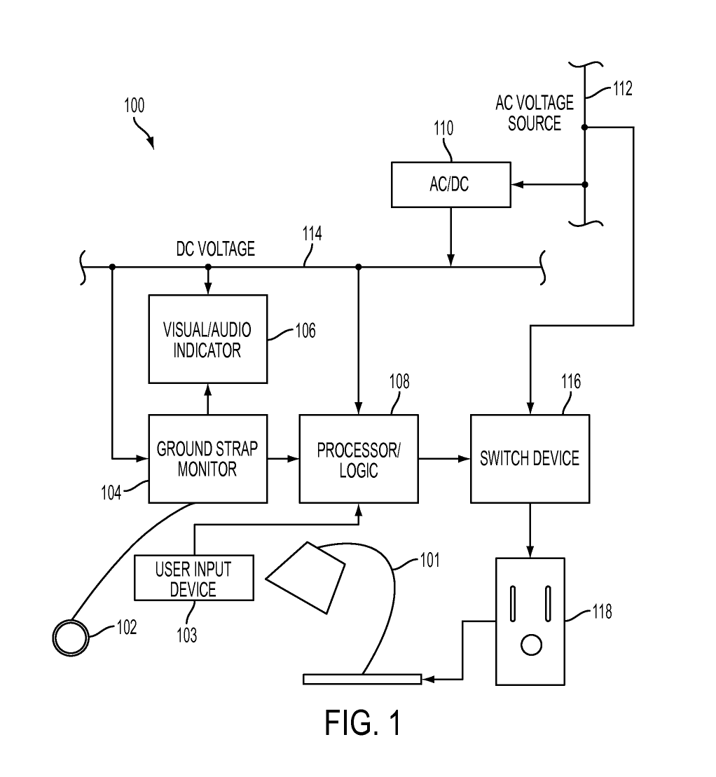

FIG. 1 illustrates a block diagram of an exemplary embodiment of an ESD monitoring system 100. In this regard, the system 100 includes a ground strap 102 that may include, for example, a bracelet that is worn by the technician. The ground strap 102 is communicatively connected to a ground strap monitor portion 104 that electronically monitors whether the technician is properly grounded by the ground strap 102. The ground strap monitor portion 104 is communicatively connected to a visual and/or audio indicator portion 106 that may include, for example, lights, a graphical or textual display, or an audio output device that is operative to indicate a status of the ESD monitoring system. In this regard, the status may include that the ground strap 102 is disconnected from the ground strap monitor portion 104, or disconnected from the technician. The status may also include a loss of ground that may occur due to an improper connection between the grounding strap and the technician, or a loss of ground in the ESD monitoring system 100. In operation, the ground strap monitor portion 104 may output a signal to the indicator portion 106 that is indicative of the status of the ESD monitoring system to be displayed by the indicator portion 106. The system 100 includes a processor or logic portion 108 that is communicatively connected to the ground strap monitor portion 104. The logic portion 108 receives a signal from the ground strap monitor portion 104 that is indicative of the status of the ESD monitoring system 100 and performs logic responsive to receiving (or not receiving) the signal. The logic portion 108 is communicatively connected to a switch device 116 having at least two connective states that may be controlled by the logic portion 108. The switch device 116 may include, for example, a relay or a solid state switching device having connective terminals that may be switched between states. The switch device is communicatively connected to an AC voltage source 112 and an outlet 118. In the illustrated embodiment, an AC powered device 101 is connected to the outlet 118 and is operative to selectively receive AC voltage as determined by the state of the switch device 116. The ESD monitoring system may include a user input device 103 such as, for example a switch, that communicatively connected to the logic portion 108, and is operative to set an operating mode of the ESD monitoring system 100. The ESD monitoring system 100 includes an AC to direct current (DC) power supply or rectifier portion 110 that is operative to convert the AC voltage into a desired DC voltage.

In operation, when the ground strap monitor portion 104 senses a loss of ground or a loss of a communicative connection between the ground strap 102 and the ESD monitoring system 100, the ground strap monitor portion 104 outputs a signal to the logic portion 108. The logic portion 108 controls the state of the switch device 116 to either close or open the connection between the outlet 118 and the AC voltage source 110. Whether the logic portion 108 opens or closes the connection between the outlet 118 and the AC voltage source 112 may be determined by a operation mode setting that may be set by a user using, for example, the user input device 103. For example, a user may connect a work light to the outlet 118 that receives power while the ground strap 102 is connected to the ESD monitoring system 100 and properly grounding the user. If a loss of ground is sensed by the ground strap monitor portion 104, the logic portion receives a signal and changes the state of the switch device 116 to an open state that disconnects the outlet (and the work light) from the AC voltage source 112, thus notifying the user of the state of the ESD system by turning the work light off. Alternatively, the user may prefer that the work light is in an off state while the ground strap 102 is connected to the ESD monitoring system 100 and properly grounding the user. Thus, the user may set the mode of the ESD monitoring system 100 to switch the state of the switch device 116 to a closed state that affects a connection between the AC voltage source 112 and the outlet 118 (and the work light) such that the work light is switched on if a signal indicative that the ground strap monitor portion 104 has sensed a loss of ground by the ESD monitoring system is received by the logic portion 108.

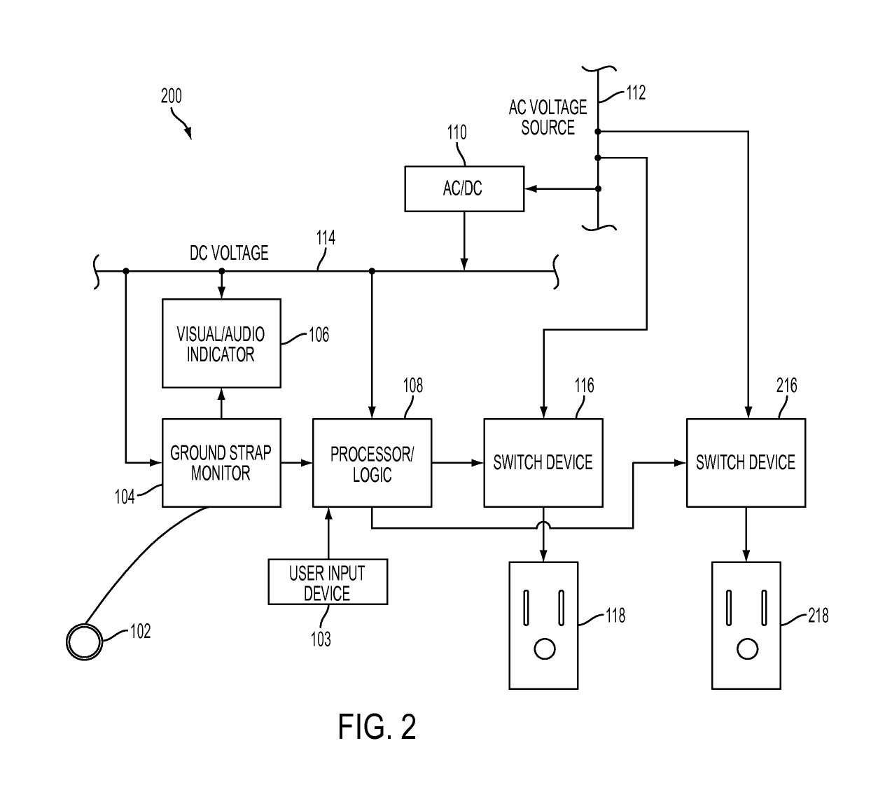

FIG. 2 illustrates a block diagram of an alternate exemplary embodiment of an ESD monitoring system 200. The ESD monitoring system 200 is similar to the embodiments described above, however the ESD monitoring system 200 includes a second switch device 216 communicatively connected to the logic portion 108 and the AC voltage source, and a second outlet 218 communicatively connected to the second switch device 216. The mode of operation of the ESD monitoring system 200 may be selected by the user via the user input device 103. In this regard, the user may set the mode of operation such that the first switch device 116 and the second switch device 216 share the same state. For example, both the first switch device 116 and the second switch device 216 may be in a closed state (i.e., providing AC voltage to the outlets 118 and 218) while the ground strap monitor portion 104 senses a proper ground and connection of the ground strap 102 to the user, and switched to an open state, if the ground strap monitor portion 104 fails to sense a proper ground and connection of the ground strap 102 to the user. Alternatively, in another exemplary mode, both the first switch device 116 and the second switch device 216 may be in an open state (i.e., not providing AC voltage to the outlets 118 and 218) while the ground strap monitor portion 104 senses a proper ground and connection of the ground strap 102 to the user, and switched to a closed state, if the ground strap monitor portion 104 fails to sense a proper ground and connection of the ground strap 102 to the user. In yet another mode of operation, the first switch device 116 and the second switch device 216 may be configured to have opposite states. For example, the first switch device 116 may be in an open state, if the ground strap monitor portion 104 senses a proper ground and connection of the ground strap 102 to the user while the second switch device 216 is in a closed state. If the ground strap monitor portion 104 fails to sense a proper ground and connection of the ground strap 102 to the user, the logic portion 108 receives a signal and changes the states of the switch devices 116 and 118. (E.g., the first switch device 116 is set to a closed state, and the second switch device 216 is set to an open state.) Thus, in the illustrated exemplary embodiment, a user may connect a work light to the first outlet 118 and a sound emitting device 218 to the second outlet 218 that each may be turned off or on depending on the mode of operation of the ESD monitoring system set by the user, and the state of the ground strap 102 connection and ground sensed by the ground strap monitor portion 104.

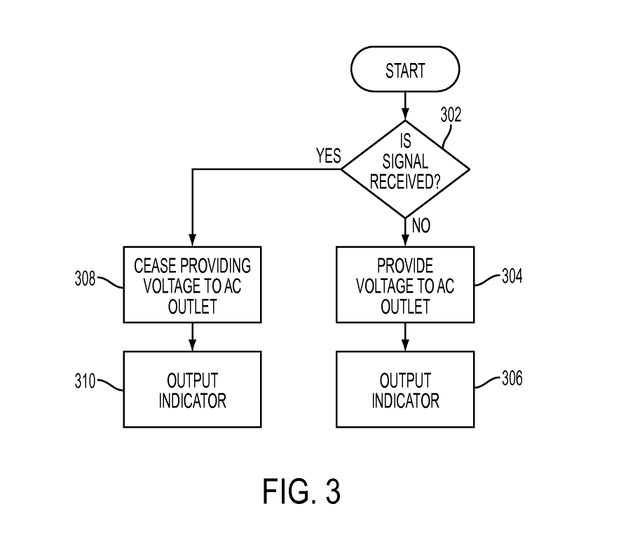

FIG. 3 illustrates a block diagram of an exemplary method of operation of an ESD monitoring system similar to the embodiments described above. In block 302 the system determines whether a signal is received. In this regard, a signal indicates that an undesirable ESD condition may exist. (I.e., the ESD monitoring system senses a loss of ground or loss of connection in the system). If no, in block 304, AC voltage is provided to the AC outlet. A visual indicator, such as, for example, a green light, may be output and displayed to a user in some exemplary embodiments in block 306. If yes, in block 308, AC voltage ceases to be provided to the AC outlet. A visual indicator, such as, for example, a red light, or an audible indicator such as, for example, a tone or buzzer may be output in block 310 in some exemplary embodiments.

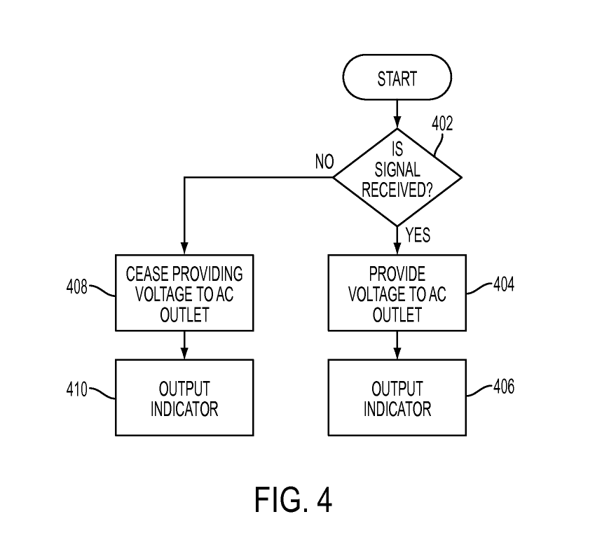

FIG. 4 illustrates a block diagram of an alternate exemplary method of operation of an ESD monitoring system similar to the embodiments described above. In this regard, in block 402, the system determines whether a signal is received. In this regard, a signal indicates that an undesirable ESD condition may exist. If yes, in block 404, AC voltage is provided to the AC outlet. A visual indicator, such as, for example, a red light, may be output and displayed to a user in some exemplary embodiments in block 406. If no, in block 408, AC voltage ceases to be provided to the AC outlet. A visual indicator, such as, for example, a green light, or an audible indicator such as, for example, a tone or buzzer may be output in block 410 in some exemplary embodiments.

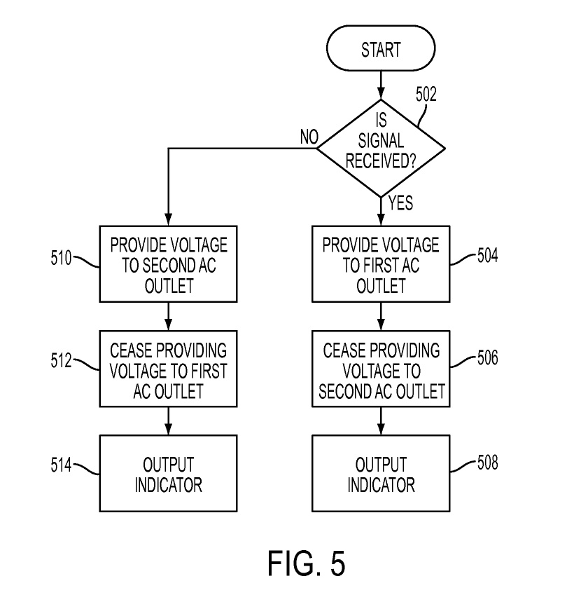

FIG. 5 illustrates a block diagram of another alternate exemplary method of operation of an ESD monitoring system similar to the illustrated embodiment of FIG. 2 described above. In this regard, in block 502, the system determines whether a signal is received. In this regard, a signal indicates that an undesirable ESD condition may exist. If yes, in block 504, AC voltage is provided to the first AC outlet. In block 506, AC voltage ceases to be provided to the second AC outlet. A visual indicator, such as, for example, a red light, may be output and displayed to a user in some exemplary embodiments in block 508. If no, in block 510, AC voltage is provided to the second AC outlet. In block 512, AC voltage ceases to be provided to the first AC outlet. A visual indicator, such as, for example, a green light, or an audible indicator such as, for example, a tone or buzzer may be output in block 514 in some exemplary embodiments.

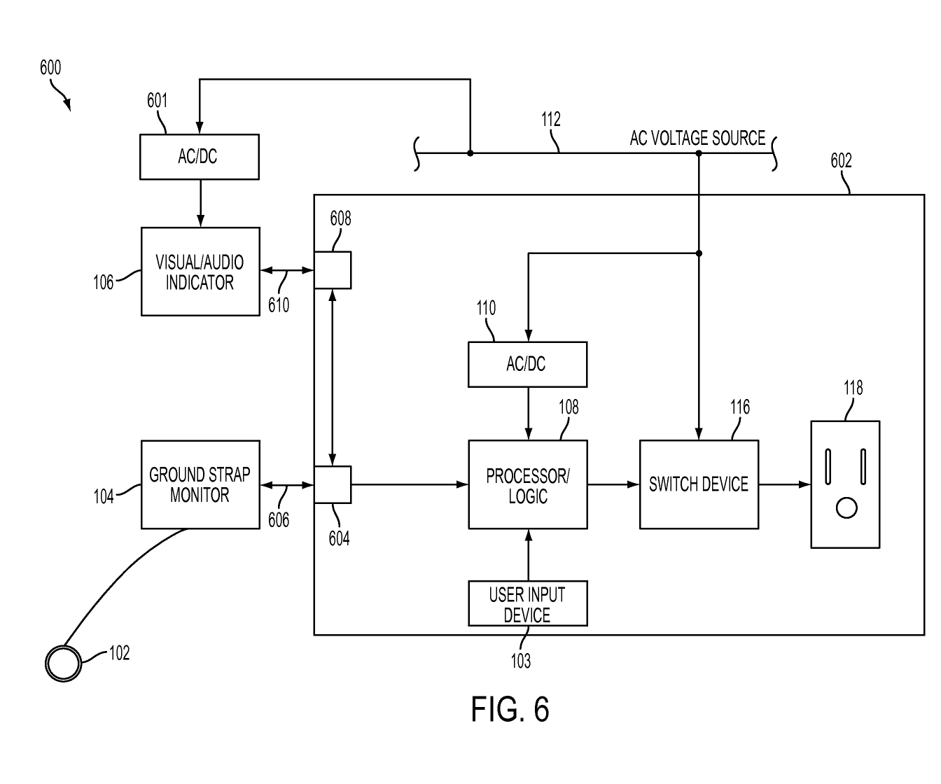

FIG. 6 illustrates another exemplary embodiment of an ESD monitoring system 600. The ESD monitoring system 600 includes an outlet control portion 602 that includes a logic portion 108, a switch device 116, an AC to DC power supply portion 110, and an outlet 118. The ground strap monitor portion 104 may be communicatively connected to the indicator portion 106 and the logic portion 108 via a communicative connection 606 such as, for example, a wire or cable via an external connector portion 604. The external connector portion 604 is communicatively connected to an external connector portion 608. The exemplary embodiment of FIG. 6 may operate in a similar manner as the embodiments described above and provides for the integration of previous ESD monitoring system components (e.g., the ground strap 102, ground strap monitor portion 104, and indicator portion 106 and associated power supply 601) with a logically switched AC outlet 118.

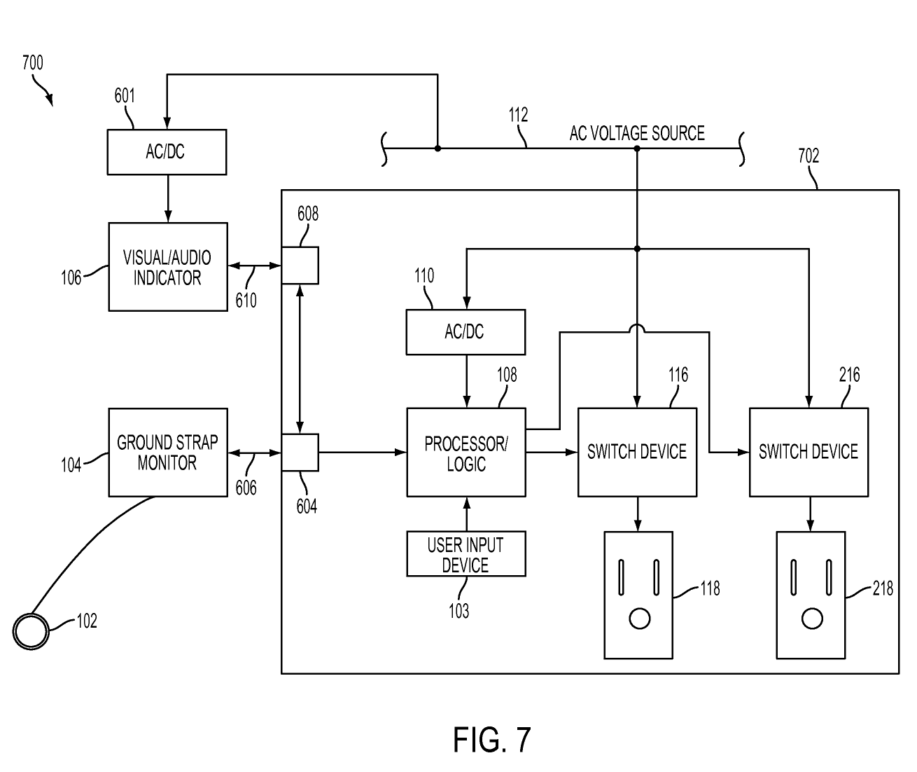

FIG. 7 illustrates yet another exemplary embodiment of an ESD monitoring system 700. The ESD monitoring system 700 includes outlet control portion 702 having similar external connector portions 604 and 608 as described above. The outlet control portion 702 includes a second switch device 216 and a second outlet 218. The outlet control portion 702 operates in a similar manner as the ESD monitoring system 200 (of FIG. 2) described above.

The technical effects and benefits of the embodiments described herein provide an ESD monitoring system that may be used to operate any number or type of AC devices to provide an indication to a user of the status of the ESD monitoring system.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated

The flow diagrams depicted herein are just one example. There may be many variations to this diagram or the steps (or operations) described therein without departing from the spirit of the disclosure. For instance, the steps may be performed in a differing order or steps may be added, deleted or modified. All of these variations are considered a part of the claimed disclosure.

While an exemplary embodiment of the disclosure has been described, it will be understood that those skilled in the art, both now and in the future, may make various improvements and enhancements which fall within the scope of the claims which follow. These claims should be construed to maintain the proper protection for the invention first described.

What is claimed is:

1. An electrostatic discharge (ESD) monitoring system comprising:
a first switch device;
a first outlet communicatively connected to the first switch device; and
a logic portion communicatively connected to the first switch device, the logic portion operative to receive a signal from a ground strap monitor portion indicative of a status of the ESD monitoring system and change a state of the first switch device responsive to receiving the signal.

2. The system of claim 1, wherein the outlet is communicatively connected to an alternating current (AC) voltage source via the first switch device.

3. The system of claim 1, further comprising a ground strap communicatively connected to the ground strap monitor portion.

4. The system of claim 1, further comprising an indicator portion communicatively connected to the ground strap monitor portion, the indicator portion operative to receive the signal from the ground strap monitor portion and output a visual indicator indicative of the status of the ESD monitoring system.

5. The system of claim 1, further comprising an indicator portion communicatively connected to the ground strap monitor portion, the indicator portion operative to receive the signal from the ground strap monitor portion and output an audible indicator indicative of the status of the ESD monitoring system.

6. The system of claim 1, further comprising a user input device communicatively connected to the logic portion, the user input device is operative to set an operational mode of the ESD monitoring system.

7. The system of claim 1, further comprising:
a second switch device; and
a second outlet communicatively connected to the second switch device, wherein the logic portion is communicatively connected to the second switch device, the logic portion operative change a state of the second switch device responsive to receiving the signal.

8. A method of operating an electrostatic discharge (ESD) monitoring system, the method comprising:
determining whether a signal from a ground strap monitor portion indicative of an ungrounded status of the ESD monitoring system is received; and
affecting a connection between an alternating current (AC) voltage source and an outlet responsive to receiving the signal.

9. The method of claim 8, wherein the affecting the connection between the AC voltage source and the outlet responsive to receiving the signal includes closing the connection between the AC voltage source and the outlet.

10. The method of claim 8, wherein the affecting the connection between the AC voltage source and the outlet responsive to receiving the signal includes opening the connection between the AC voltage source and the outlet.

11. The method of claim 8, further comprising outputting a visual indicator to a user responsive to receiving the signal.

12. The method of claim 8, further comprising outputting an audible indicator to a user responsive to receiving the signal.

13. A method of operating an electrostatic discharge (ESD) monitoring system, the method comprising:
determining whether a signal from a ground strap monitor portion indicative of an ungrounded status of the ESD monitoring system is received;
affecting a connection between an alternating current (AC) voltage source and a first outlet responsive to receiving the signal; and
affecting a connection between the AC voltage source and a second outlet responsive to receiving the signal.

14. The method of claim 13, wherein the affecting the connection between the AC voltage source and the first outlet responsive to receiving the signal includes closing the connection between the AC voltage source and the first outlet.

15. The method of claim 13, wherein the affecting the connection between the AC voltage source and the first outlet responsive to receiving the signal includes opening the connection between the AC voltage source and the first outlet.

16. The method of claim 13, wherein the affecting the connection between the AC voltage source and the second outlet responsive to receiving the signal includes closing the connection between the AC voltage source and the first second.

17. The method of claim 13, wherein the affecting the connection between the AC voltage source and the second outlet responsive to receiving the signal includes opening the connection between the AC voltage source and the second outlet.

18. The method of claim 13, further comprising outputting a visual indicator to a user responsive to receiving the signal.

19. The method of claim 13, further comprising outputting an audible indicator to a user responsive to receiving the signal.

20. The method of claim 13, further comprising determining an operating mode of the ESD monitoring system set by a user.
